(19) United States
(12) Patent Application Publication
(10) Pub. No.: US 2026/0160991 A1
(43) Pub. Date: Jun. 11, 2026

(54) OPTICAL MODULE

(71) Applicant: TDK TAIWAN CORP., Taoyuan City (TW)

(72) Inventors: Yi-Ho CHEN, Taoyuan City (TW); Mao-Kuo HSU, Taoyuan City (TW); Ying-Jen WANG, Taoyuan City (TW); Yu-Chi KUO, Taoyuan City (TW); Sz-Hsuan LIU, Taoyuan City (TW)

(21) Appl. No.: 19/181,638

(22) Filed: Apr. 17, 2025

Related U.S. Application Data
(60) Provisional application No. 63/636,417, filed on Apr. 19, 2024.

(51) Int. Cl. G02B 26/08; G02B 7/02

(52) U.S. Cl. CPC G02B 26/0875; G02B 7/025

(57) ABSTRACT

An optical module is provided, including a fixed part, a lens unit, and a driving unit. The lens unit is movably connected to the fixed part, and the driving unit is configured to move the lens unit relative to the fixed part. The optical module further includes an annular flexible sheet connected between the fixed part and the lens unit. The flexible sheet has an inner portion affixed to the lens unit, an outer portion affixed to the fixed part, and a connecting portion connected between the inner and outer portions.

### CROSS REFERENCE TO RELATED APPLICATIONS

This Application claims priority of U.S. Provisional Application No. 63/636,417, filed Apr. 19, 2024, the entirety of which is incorporated by reference herein.

### BACKGROUND OF THE INVENTION

### FIELD OF THE INVENTION

The present invention relates to an optical module, and, in particular, to an optical module having a piezoelectric driving unit.

### Description of the Related Art

In recent years, it has often become the practice for a plurality of camera devices to be installed on a vehicle to detect and monitor objects around the vehicle (e.g. autonomous cars). However, foreign matter such as mud, dust, fallen leaves, snow, raindrops, or water droplets may become attached to the transparent covers of the camera devices after long-term use, and the quality of the images captured by the camera devices can be adversely affected. Therefore, addressing the aforementioned problems has becomes a challenge.

### BRIEF SUMMARY OF THE INVENTION

An embodiment of the present invention provides an optical module that includes a fixed part, a lens unit, and a driving unit. The lens unit is movably connected to the fixed part, and the driving unit is configured to move the lens unit relative to the fixed part.

In some embodiments, the optical module further includes an annular flexible sheet connected between the fixed part and the lens unit. The flexible sheet has an inner portion affixed to the lens unit, an outer portion affixed to the fixed part, and a deformable connecting portion connected between the inner and outer portions.

### BRIEF DESCRIPTION OF THE DRAWINGS

The present invention can be more fully understood by reading the subsequent detailed description and examples with references made to the accompanying drawings, wherein:

FIG. 1 is an exploded diagram of an optical module 100, in accordance with an embodiment of the invention.

FIG. 2 is another exploded diagram of the optical module 100 in FIG. 1.

FIG. 3 is a perspective diagram of the optical module 100 in FIGS. 1 and 2 after assembly.

FIG. 4 is another perspective diagram of the optical module 100 in FIGS. 1 and 2 after assembly.

FIG. 5 is a cross-sectional view of the optical module 100.

FIG. 6 is a partial enlarged view of the optical module 100 in FIG. 5.

FIG. 7 is a partial cross-sectional view of the optical module 100 in accordance with another embodiment of the invention.

FIG. 8 is a partial cross-sectional view of the optical module 100 in accordance with another embodiment of the invention, wherein the base 60 forms an inner wall 602 surrounding the opening 61.

### DETAILED DESCRIPTION OF THE INVENTION

The making and using of the embodiments of the optical module are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

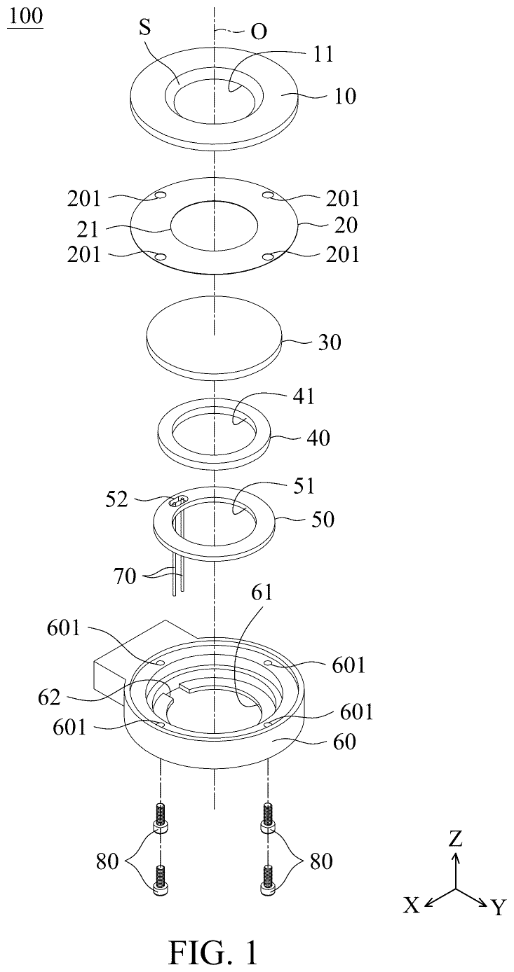

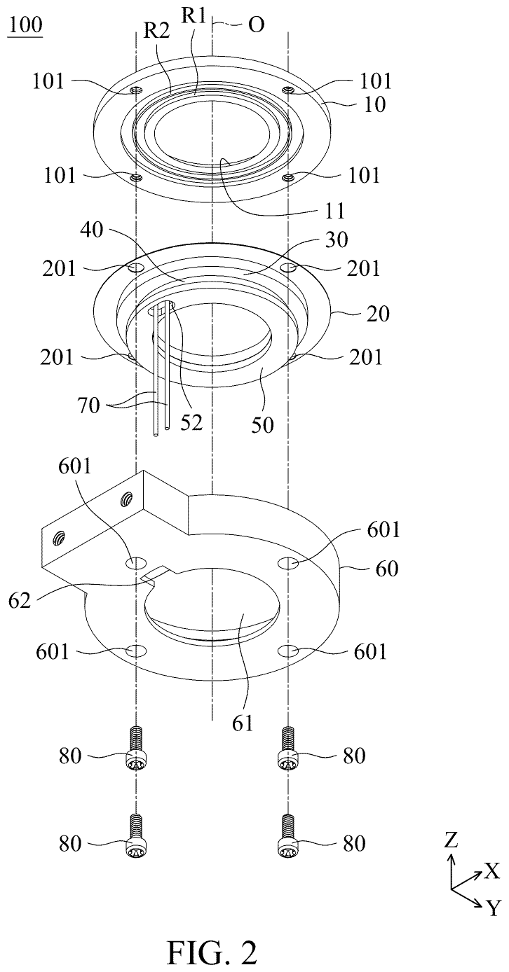

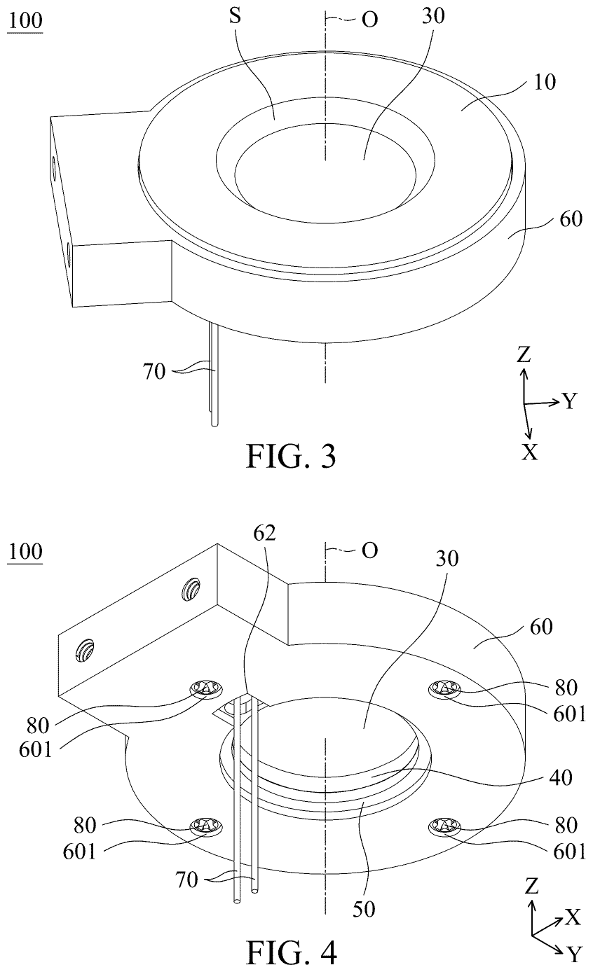

FIG. 1 is an exploded diagram of an optical module 100, in accordance with an embodiment of the invention. FIG. 2 is another exploded diagram of the optical module 100 in FIG. 1. FIG. 3 is a perspective diagram of the optical module 100 in FIGS. 1 and 2 after assembly. FIG. 4 is another perspective diagram of the optical module 100 in FIGS. 1 and 2 after assembly.

Referring to FIGS. 1-4, the optical module 100 may be connected to a camera device that is disposed on a vehicle for detecting and monitoring the objects around the vehicle (e.g. autonomous car). In this embodiment, the optical module 100 primarily comprises an annular cap 10, an annular flexible sheet 20, a lens unit 30, an annular driving unit 40, an annular weight block 50, a hollow base 60, at least a wire 70, and at least a fastener 80.

The cap 10 and the base 60 are affixed to each other to constitute a housing (fixed part) of the optical module 100. Additionally, the lens unit 30 is movably connected to the cap 10 via the flexible sheet 20, thereby constituting a movable part of the optical module 100. In this embodiment, the flexible sheet 20 may be a polyimide sheet adhered to the cap 10 and the lens unit 30. The lens unit 30 may comprise a transparent flat lens, a filter lens, or another optical element to protect the camera device (not shown) disposed under the optical module 100.

Moreover, the driving unit 40 comprises piezoelectric material and is connected between the lens unit 30 and the weight block 50. Two wires 70 extend from the driving unit 40 through the hole 52 of the weight block 50 and the recess 62 of the base 60 to an external circuit (not shown) in the-Z direction.

When a current is applied from the external circuit through the wires 70 to the driving unit 40, the lens unit 30 can be driven to vibrate by the driving unit 40. Therefore, the foreign matter such as snow or raindrops on the lens unit 30 can be removed to ensure high quality of the images captured by the camera device. In this embodiment, the weight block 50 may comprise metal material to facilitate stable and efficient vibration of the driving unit 40 and the lens unit 30, whereby the foreign matter adhered to the lens unit 30 can be shaken off and removed quickly.

It can also be seen in FIGS. 1 and 2 that the cap 10, the flexible sheet 20, the lens unit 30, the driving unit 40, the weight block 50, and the base 60 are arranged along the optical axis O of the lens unit 30. Here, the optical axis O extends through the opening 11 of the cap 10, the opening 21 of the flexible sheet 20, the lens unit 30, the opening 41 of the driving unit 40, the opening 51 of the weight block 50, and the opening 61 of the base 60.

During assembly, several fasteners 80 (e.g. screws) are inserted sequentially through the holes 601 of the base 60 and the holes 201 of the flexible sheet 20 to the cap 10. As shown in FIG. 2, the ends of the fasteners 80 can be secured in the threaded holes 101 of the cap 10, whereby the lens unit 30, the driving unit 40, and the weight block 50 can be suspended in the space between the cap 10 and the base 60 by the flexible sheet 20.

Still referring to FIG. 2, a first annular recess R1 and a second annular recess R2 are formed on the bottom side of the cap 10 and arranged in a concentric manner. During assembly of the optical module 100, the glue and/or O-ring are disposed in the first and second recesses R1 and R2 and are in contact with the flexible sheet 20, thereby preventing water and dust from entering the optical module 100.

As shown in FIGS. 1 and 3, the cap 10 forms a slope surface S adjacent to the opening 11. Here, the slope surface S is angled relative to the optical axis O of the lens unit 30.

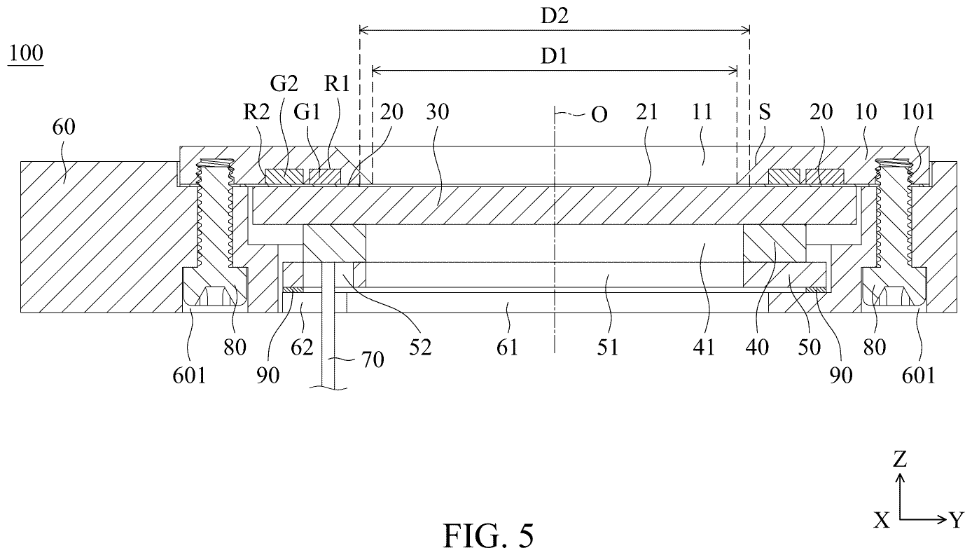

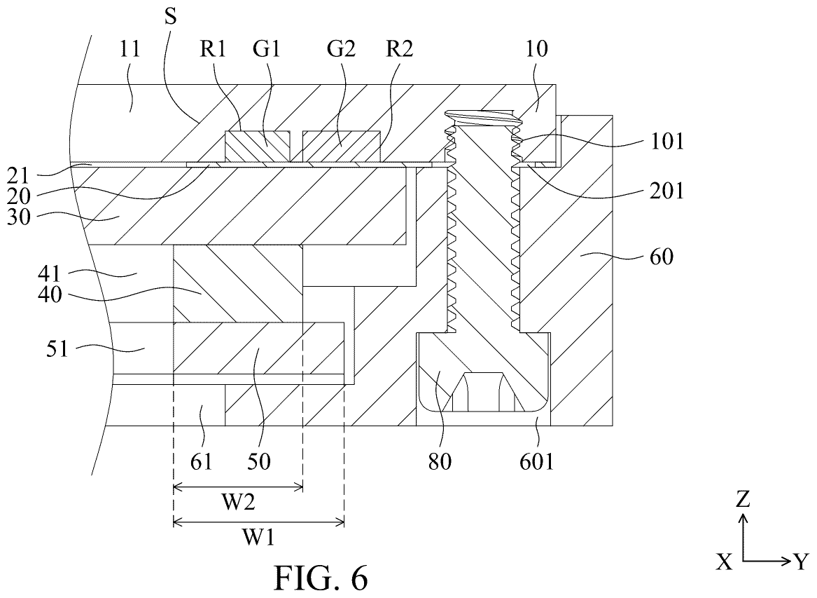

FIG. 5 is a cross-sectional view of the optical module 100. FIG. 6 is a partial enlarged view of the optical module 100 in FIG. 5.

Referring to FIGS. 5-6, the optical axis O extends sequentially through the opening 11 of the cap 10, the opening 21 of the flexible sheet 20, the lens unit 30, the opening 41 of the driving unit 40, the opening 51 of the weight block 50, and the opening 61 of the base 60. Additionally, the wires 70 extend from the driving unit 40 through the hole 52 of the weight block 50 and the recess 62 of the base 60 in the-Z direction.

It can also be seen in FIGS. 5 and 6 that a first sealing element G1 is fitted in the first annular recess R1 of the cap 10, and a second sealing element G2 is fitted in the second annular recess R2 of the cap 10, wherein the Young's modulus of the first sealing element G1 is different from (e.g. smaller than) the Young's modulus of the second sealing element G2. It should be noted that the first and second sealing elements G1 and G2 are arranged in a concentric manner and surround the optical axis O of the lens unit 30. Specifically, the opening 11 (first opening) of the cap 10 has a first minimum diameter D1, and the opening 21 (second opening) of the flexible sheet 20 has a second minimum diameter D2, wherein the second minimum diameter D2 is greater than the first minimum diameter D1 (FIG. 5).

In this embodiment, the first sealing element G1 may comprise the glue, and the second sealing element G2 may comprise an O-ring surrounding the glue. In some embodiments, the first sealing element G1 may comprise an O-ring, and the second sealing element G2 may comprise the glue surrounding the O-ring.

In some embodiments, both of the first and second sealing elements G1 and G2 may comprise O-ring or the glue. In some embodiments, the glue can also be disposed in the holes 101, 201, and 601 to firmly adhere the cap 10, the base 60, and the flexible sheet 20 to each other even when the fasteners 80 are omitted from the optical module 100.

In some embodiments, the glue may be applied in the holes 601 from the bottom side of the base 60 to cover and secure the fasteners 80 in the holes 601, thereby achieving waterproof function of the optical module 100.

FIGS. 5 and 6 further shows at least a damping gel element 90 is connected between the weight block 50 and the base 60, thereby preventing the weight block 50 from collision with the base 60.

It should be noted that the weight block 50 has a first width W1 in the horizontal direction (Y direction), and the driving unit 40 has a second width W2 in the horizontal direction (Y direction) that is less than the first width W1, thereby improving the structural stability of the lens unit 30.

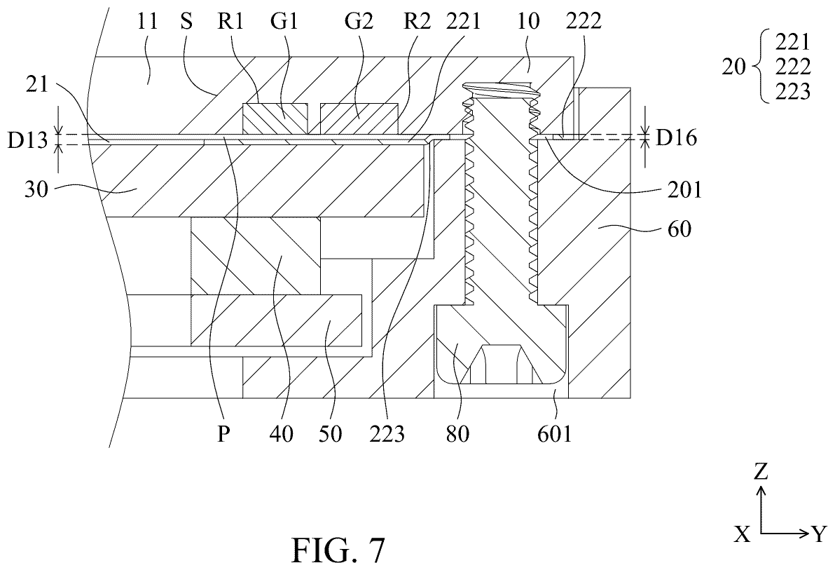

FIG. 7 is a partial cross-sectional view of the optical module 100 in accordance with another embodiment of the invention. Referring to FIG. 7, in another embodiment of the invention, the first and second sealing elements G1 and G2 may slightly protrude from the bottom surface of the cap 10. In this configuration, a gap P is formed between the cap 10 and the flexible sheet 20. Moreover, a first distance D13 is formed between the cap 10 and the lens unit 30 along the Z direction, and a second distance D16 is formed between the cap 10 and the base 60 along the Z direction, wherein the first distance D13 is greater than the second distance D16.

It should be noted that the flexible sheet 20 in FIG. 7 has an inner portion 221, an outer portion 222, and a connecting portion 223 connected between the inner and outer portions 221 and 222. The inner portion 221 adheres to the top surface of the lens unit 30 and is in contact with the first and second sealing elements G1 and G2 (e.g. glue or O-ring). The outer portion 222 is affixed between the cap 10 and the base 60 (fixed part). Specifically, the connecting portion 223 is deformable and connected between the inner and outer portions 221 and 222, wherein the opening 201 is formed on the outer portion 222 of the flexible sheet 20.

In this configuration, the lens unit 30, the driving unit 40, and the weight block 50 can be stably suspended in the optical module 100, and the foreign matter (e.g. water or dust) can be prevented from intrusion into the optical module 100 by the first and second sealing elements G1 and G2.

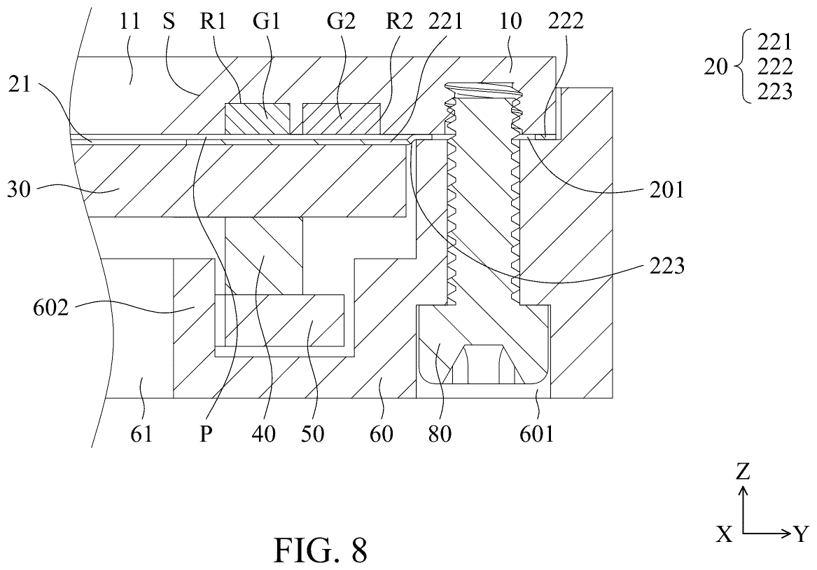

FIG. 8 is a partial cross-sectional view of the optical module 100 in accordance with another embodiment of the invention.

Referring to FIG. 8, in another embodiment of the invention, the base 60 forms an inner wall 602 surrounding the opening 61. It should be noted that the inner wall 602 is situated between the opening 61 of the base 60 and the driving unit 40/the weight block 50. When viewed in the horizontal direction (X or Y direction) perpendicular to the optical axis O (Z direction), the inner wall 602 at least partially overlap the driving unit 40 and the weight block 50.

In this configuration, a part of the camera device may be accommodated in the opening 61 of the base 60 and surrounded by the inner wall 602. Moreover, the stray light can be blocked by the inner wall 602 of the base 60, thereby efficiently avoiding lens flare of the camera device.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical module, comprising:
a fixed part;
a lens unit, movably connected to the fixed part; and
a driving unit, configured for moving the lens unit relative to the fixed part.

2. The optical module as claimed in claim 1, further comprising an annular flexible sheet connected between the fixed part and the lens unit.

3. The optical module as claimed in claim 2, wherein the flexible sheet has an inner portion affixed to the lens unit, an outer portion affixed to the fixed part, and a deformable connecting portion connected between the inner and outer portions.

4. The optical module as claimed in claim 3, wherein the fixed part includes a cap and a base affixed to each other, and the outer portion is connected between the cap and the base.

5. The optical module as claimed in claim 4, further comprising a first sealing element, wherein the cap has a first annular recess surrounding an optical axis of the lens unit, and the first sealing element is disposed in the first annular recess and is in contact with the flexible sheet.

6. The optical module as claimed in claim 5, wherein the first sealing element comprises a glue or an O-ring.

7. The optical module as claimed in claim 5, further comprising a second sealing element, wherein the cap further has a second annular recess surrounding first annular recess, and the second sealing element is disposed in the second annular recess and is in contact with the flexible sheet.

8. The optical module as claimed in claim 7, wherein the second sealing element comprises a glue or an O-ring.

9. The optical module as claimed in claim 7, wherein the width of the second annular recess is greater than the width of the first annular recess.

10. The optical module as claimed in claim 5, wherein the driving unit comprises piezoelectric material.

11. The optical module as claimed in claim 5, wherein the flexible sheet comprises a polyimide sheet.

12. The optical module as claimed in claim 5, wherein a gap is formed between the cap and the flexible sheet.

13. The optical module as claimed in claim 5, wherein a first distance is formed between the cap and the lens unit along the optical axis, and a second distance is formed between the cap and the base along the optical axis, wherein the first distance is greater than the second distance.

14. The optical module as claimed in claim 5, wherein the optical axis of the lens unit extends through a first opening of the cap and a second opening of the flexible sheet, the first opening has a first minimum diameter, and the second opening has a second minimum diameter that is greater than the first minimum diameter.

15. The optical module as claimed in claim 5, further comprising an annular weight block, wherein the driving unit is connected between the flexible sheet and the weight block.

16. The optical module as claimed in claim 15, further comprising a wire, wherein the weight block forms a hole, and the wire extends through the hole and the base to an external circuit.

17. The optical module as claimed in claim 15, wherein the weight block comprises metal, and the lens unit comprises a transparent flat lens or a filter lens.

18. The optical module as claimed in claim 5, further comprising a damping gel element connected between the weight block and the base.

19. The optical module as claimed in claim 5, further comprising a fastener, wherein the outer portion forms a hole, and the fastener is inserted through the base and the hole to the cap.

20. The optical module as claimed in claim 5, wherein the optical axis of the lens unit extends through an opening of the base, and the base forms an inner wall situated between the driving unit and the opening.
